(19) United States
(12) Patent Application Publication
(10) Pub. No.: US 2026/0277167 A1
(43) Pub. Date: Sep. 17, 2026

(54) SCHEDULE MANAGEMENT METHOD, AND ELECTRONIC DEVICE FOR SUPPORTING SAME

(71) Applicant: Samsung Electronics Co., Ltd., Suwon-si (KR)

(72) Inventor: Hyorin OH, Suwon-si (KR)

(21) Appl. No.: 19/669,323

(22) Filed: May 6, 2026

Related U.S. Application Data
(63) Continuation of application No. PCT/KR2024/019018, filed on Nov. 27, 2024.

(30) Foreign Application Priority Data
Jan. 8, 2024 (KR) 10-2024-0003029
Feb. 27, 2024 (KR) 10-2024-0027665

(51) Int. Cl. G04G 13/02; G04G 21/02

(52) U.S. Cl. CPC G04G 13/021; G04G 21/02

(57) ABSTRACT

An electronic device is provided. The electronic device includes a communication module, at least one processor including a processing circuit, and memory for storing at least one storage medium, wherein the at least one storage medium store instructions that, when executed individually or in combination by the at least one processor, cause the electronic device to obtain schedule information based on a user input, determine a start time associated with a schedule based on at least part of the schedule information, set a preparation time for generating of an automatic alarm generation based on the start time, in response to an arrival of the preparation time, determine whether a sleep state of a user is maintained using information received through the communication module, in response to the determining that the sleep state of the user is maintained, determine an alarm occurrence time of the automatic alarm based on the at least part of the schedule information, and generate the automatic alarm based on the automatic alarm occurrence time of the automatic alarm.

### CROSS-REFERENCE TO RELATED APPLICATION(S)

This application is a continuation application, claiming priority under 35 U.S.C. § 365 (c), of an International application No. PCT/KR2024/019018, filed on Nov. 27, 2024, which is based on and claims the benefit of a Korean patent application number 10-2024-0003029, filed on Jan. 8, 2024, in the Ministry of Intellectual Property (MOIP), and of a Korean patent application number 10-2024-0027665, filed on Feb. 27, 2024, in the Ministry of Intellectual Property (MOIP), the disclosure of each of which is incorporated by reference herein in its entirety.

### BACKGROUND

### 1. Field

The disclosure relates to a schedule management method and an electronic device that supports the same.

### 2. Description of Related Art

With the development of digital technologies, a variety of electronic devices capable of communicating and processing personal information on the go, such as mobile terminals, electronic organizers, smartphones, tablet personal computers (PCs), and wearable devices, are being released. Through rapid technological advancements, these electronic devices have evolved from simple voice calls and messaging to include diverse functions such as video calls, electronic organizers, document processing, email, Internet access, and photography.

Moreover, an electronic device may provide a schedule management function. For example, a user may manage his/her schedule at any time by registering schedules, such as appointment dates, meeting times, or anniversaries, on the electronic device.

Furthermore, the electronic device may provide alarm information about registered schedules. For example, the user may register an alarm time (e.g., 10 minutes before the schedule is performed) for a schedule on the electronic device. When the alarm time arrives, the electronic device may provide specified alarm information (e.g., visual alarm information, auditory alarm information, or tactile alarm information).

The above information is presented as background information only to assist with an understanding of the disclosure. No determination has been made, and no assertion is made, as to whether any of the above might be applicable as prior art with regard to the disclosure.

### SUMMARY

A schedule management function of the aforementioned electronic device merely notifies a user of schedule details at the registered alarm times, and thus falls somewhat short in effectively providing alarms for registered schedules.

For example, when an alarm time for a schedule is not specified, the user may not receive alarm information about schedule details, and thus, a situation where the user is unaware of the registered schedule may arise.

Furthermore, when a sufficient preparation time (or time required) for performing the schedule is not secured (e.g., when there is an insufficient time to travel to the location for performing the schedule) even though the user is aware of the schedule through the alarm information, a situation where the user is unable to properly complete the registered schedule may arise.

Aspects of the disclosure are to address at least the above-mentioned problems and/or disadvantages and to provide at least the advantages described below. Accordingly, an aspect of the disclosure is to provide a schedule management method for effectively providing alarm information about a registered schedule and an electronic device supporting the same.

Another aspect of the disclosure is to provide a schedule management method for automatically generating an alarm related to the initiation of schedule preparation based on the characteristics of a registered schedule, and an electronic device supporting the same.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry configured to establish communication with an external device, memory including one or more storage media storing instructions, and at least one processor including processing circuitry, wherein the instructions, when executed by the at least one processor individually or collectively, cause the electronic device to obtain schedule information based on a user input, determine a start time associated with a schedule based on at least part of the schedule information, set a preparation time for generating of an automatic alarm generation based on the start time, in response to an arrival of the preparation time, determine whether a sleep state of a user is maintained using information received through the communication circuitry, in response to the determining that the sleep state of the user is maintained, determine an alarm occurrence time of the automatic alarm based on the at least part of the schedule information, and generate the automatic alarm based on the alarm occurrence time of the automatic alarm.

In accordance with another aspect of the disclosure, an operating method of an electronic device is provided. The method includes obtaining schedule information based on a user input, determining a start time associated with a schedule based on at least part of the schedule information, setting a preparation time for generating of an automatic alarm generation based on the start time, in response to arrival of the preparation time, determining whether a sleep state of a user is maintained using information received through the communication circuitry in response to arrival of the user is maintained, determining an alarm occurrence time of the automatic alarm based on the at least part of the schedule information, and generating the automatic alarm based on the alarm occurrence time of the automatic alarm.

In accordance with another aspect of the disclosure, one or more non-transitory computer-readable storage media storing computer-executable instructions that, when executed by one or more processors of an electronic device individually or collectively, cause the electronic device to perform operations are provided. The operations include obtaining schedule information based on a user input, determining a start time associated with a schedule based on at least part of the schedule information, setting a preparation time for generating of an automatic alarm generation based on the start time, in response to arrival of the preparation time, determining whether a sleep state of a user is maintained using information received through a communication circuitry, in response to determine that the sleep state of the user is maintained, determining an alarm occurrence time of the automatic alarm based on the at least part of the schedule information, and generating the automatic alarm based on the alarm occurrence time of the automatic alarm.

An electronic device according to the various embodiments disclosed in this specification performs effective schedule management by automatically generating alarms related to schedule preparation based on the characteristics of a registered schedule.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to an embodiment of the disclosure;

FIG. 2 is a drawing for describing a schedule management function, according to an embodiment of the disclosure;

FIG. 3 is a diagram for describing an alarm function of an electronic device, according to an embodiment of the disclosure;

FIG. 4 is a diagram for describing an operation time of an electronic device, according to an embodiment of the disclosure;

FIG. 5 is a diagram for describing an automatic alarm function, according to an embodiment of the disclosure;

FIG. 6 is a diagram for describing an operation of providing information related to an automatic alarm operation time in an electronic device, according to an embodiment of the disclosure;

FIG. 7A is a diagram for describing an operation of determining an automatic alarm operation time in an electronic device, according to an embodiment of the disclosure;

FIG. 7B is a diagram for describing a preparation time corresponding to a category of a schedule, according to an embodiment of the disclosure;

FIG. 8 is a diagram for describing an operation of determining an automatic alarm operation time in an electronic device, according to an embodiment of the disclosure;

FIGS. 9A and 9B are drawings for describing an automatic alarm providing operation of an electronic device, according to various embodiments of the disclosure;

FIG. 10 is a diagram for describing an automatic alarm operation of an electronic device, according to an embodiment of the disclosure;

FIGS. 11A and 11B are drawings for describing messages related to schedule non-attendance, according to various embodiments of the disclosure;

FIG. 12 is a diagram for describing an automatic alarm operation of an electronic device, according to an embodiment of the disclosure;

FIG. 13 is a diagram for describing a notification related to an unfulfilled schedule, according to an embodiment of the disclosure;

FIG. 14 is a diagram for describing an automatic alarm operation of an electronic device, according to an embodiment of the disclosure;

FIG. 15 is a diagram for describing an automatic alarm operation of an electronic device, according to an embodiment of the disclosure;

FIG. 16 is a flowchart for describing an operation of an electronic device, according to an embodiment of the disclosure;

FIG. 17 is a flowchart for describing an operation of an electronic device, according to an embodiment of the disclosure;

FIG. 18 is a flowchart for describing an operation of an automatic alarm system, according to an embodiment of the disclosure;

FIG. 19 is a flowchart for describing an operation of an electronic device, according to an embodiment of the disclosure;

FIG. 20 is a diagram for describing a schedule registration operation, according to an embodiment of the disclosure; and

FIG. 21 is a flowchart for describing an operation of an automatic alarm system, according to an embodiment of the disclosure

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

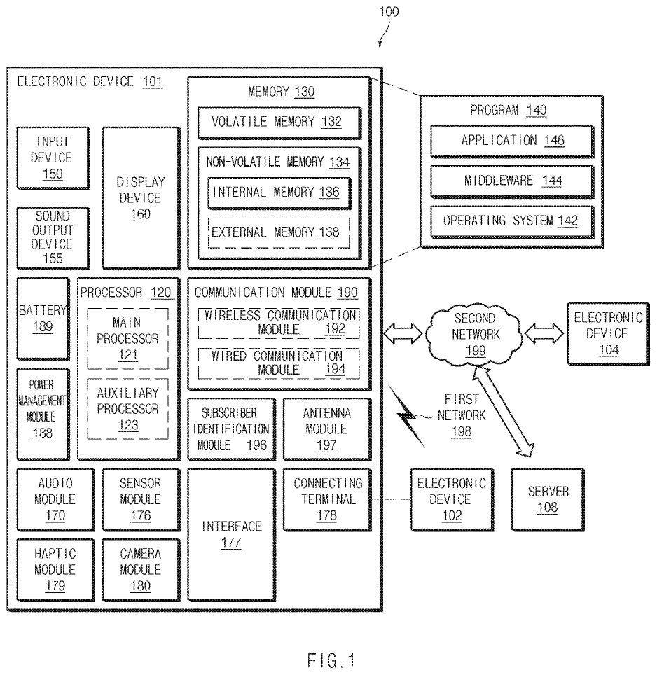

FIG. 1 is a block diagram illustrating an electronic device 101 in a network environment 100 according to an embodiment of the disclosure.

input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104 or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, the processor 120 (e.g., processing circuit) may be implemented as one or more integrated circuit (or circuitry) chips and may perform various data processing operations. The processor 120 may include at least one electrical circuit and may individually or collectively distribute and process instructions (or programs, data) stored in the memory 130. The processor 120 may include a processor assembly including one or more processing circuits. The processor 120 may include any processing circuit operative to control the performance and operations of one or more components of the electronic device 101 (e.g., the memory 130, the display module 160, the sensor module 176 (e.g., a sensor), the camera module 180 (e.g., an image sensor), and/or the communication module 190 (e.g., a communication circuit)). For example, the processor 120 (e.g., an application processor (AP)) may be implemented as a system on chip (SoC) (e.g., a single chip or a chipset). For example, the processor 120 may be implemented as a plurality of cores (or at least one core circuit), a plurality of chips, or a plurality of chipsets. For example, the processor 120 may include one or more processing circuits. For example, the processor 120 may include one or more processing circuits configured to individually and/or collectively perform various functions of the disclosure. As a non-limiting example, at least part of the processor 120 may be included in a first chip of the electronic device 101, and at least another part of the processor 120 may be included in a second chip of the electronic device 101 different from the first chip of the electronic device 101.

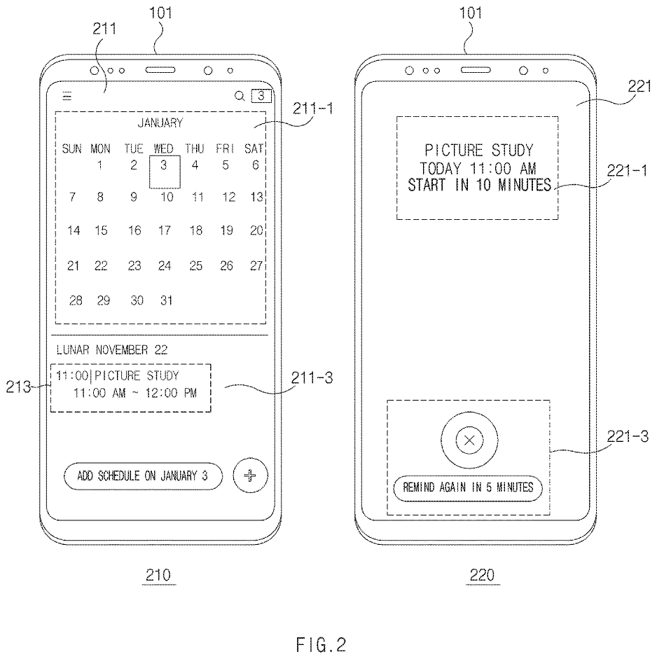

According to various embodiments, the electronic device 101 may enable effective schedule management by providing an alarm related to schedule preparation based on the characteristics of a registered schedule. This is described in detail below with reference to FIGS. 2 to 20. Furthermore, at least one embodiment (or at least part of one embodiment) among various embodiments described through FIGS. 2 to 6, 7A, 7B, 8, 9A, 9B, 10, 11A, 11B, and 12 to 20 below may be combined with other embodiments (or at least part of other embodiments).

FIG. 2 is a drawing for describing a schedule management function, according to an embodiment of the disclosure.

Referring to FIG. 2, the electronic device 101 (e.g., the processor 120) according to various embodiments may output a schedule management screen 211 that supports schedule registration, as illustrated in 210 of FIG. 2. The schedule may include activities of a user that need to be performed on a specified date.

According to various embodiments, the schedule management screen 211 may include a calendar region 211-1 and a schedule list region 211-3.

According to an embodiment, a calendar in the month unit may be output in the calendar region 211-1 as illustrated, but various embodiments are not limited thereto. For example, a calendar in the week unit, a calendar in the day unit, or an hour may be output through the calendar region 211-1.

According to an embodiment, a list of schedules registered in the electronic device 101 may be provided in a schedule list region 211-3. According to an embodiment, the schedule may be linked to a calendar and may be registered in the electronic device 101. For example, among dates displayed in the calendar region 211-1, a date on which a schedule is registered may be provided with a visual effect (e.g., a color, a font, a size, or an indicator) indicating that a schedule has been registered. For example, a visual effect applied to the date on which a schedule is registered may be different from a visual effect applied to a date on which no schedule is registered.

According to various embodiments, the electronic device 101 may register a schedule based on schedule information corresponding to a user input (e.g., a voice input, a touch input, a gesture input, or any combination thereof). According to an embodiment, the schedule information may include schedule content (e.g., a schedule title), a schedule execution time (e.g., a schedule start time), a schedule execution location (e.g., a company), a schedule execution method (e.g., a video conference), schedule stakeholders (e.g., meeting attendees), a method of moving to the schedule execution location (e.g., using public transportation), or any combination thereof. However, this is merely illustrative, and various embodiments are not limited thereto. For example, various pieces of information other than the information described above may be used as the schedule information.

According to various embodiments, based on a schedule (e.g., a picture study schedule) is registered on a specified date (e.g., January 3) through the schedule management screen 211, the electronic device 101 may output the registered schedule through the schedule list region 211-3. According to an embodiment, the electronic device 101 may output (213) at least some of the schedule information corresponding to the user input, such as the schedule content (e.g., a picture study) and a schedule execution time (e.g., 11:00 AM to 12:00 PM), along with the registered schedule.

Additionally or alternatively, the electronic device 101 may provide alarm information (e.g., visual alarm information, auditory alarm information, tactile alarm information, or any combination thereof) about the registered schedule.

According to an embodiment, the electronic device 101 may store a first alarm occurrence time (e.g., a time corresponding to 10 minutes prior to the schedule execution) for a schedule and may provide specified alarm information based on the first alarm occurrence time arrives. For example, the electronic device 101 may provide alarm information 221, which includes visual information (e.g., a schedule start in 10 minutes) 221-1 that informs schedule content while also outputting an alarm sound, as illustrated in 220 of FIG. 2. In this regard, the electronic device 101 may provide a user interface 221-3 related to alarm deactivation (or providing an alarm again after interruption), and may stop providing the alarm information 221 in response to a user input that causes the alarm deactivation.

As described above, the electronic device 101 according to various embodiments may prevent a situation, in which the user is unaware of a schedule registered in the electronic device 101, by providing alarm information.

However, when the first alarm occurrence time related to the registered schedule is not specified, the electronic device 101 may not provide alarm information about the registered schedule. In such a case, there may be difficulty for the user to be aware of the schedule registered in the electronic device 101.

Furthermore, even when the user is aware of a schedule through alarm information provided by the electronic device 101, a sufficient preparation time (or a time required) for performing the schedule may not be secured. For example, before performing a schedule, the user may perform preparation actions such as waking up, washing one's face, getting dressed, eating, or moving. However, when the preparation time is insufficient compared to the time remaining before the schedule begins, a situation where the user fails to properly complete the registered schedule may arise.

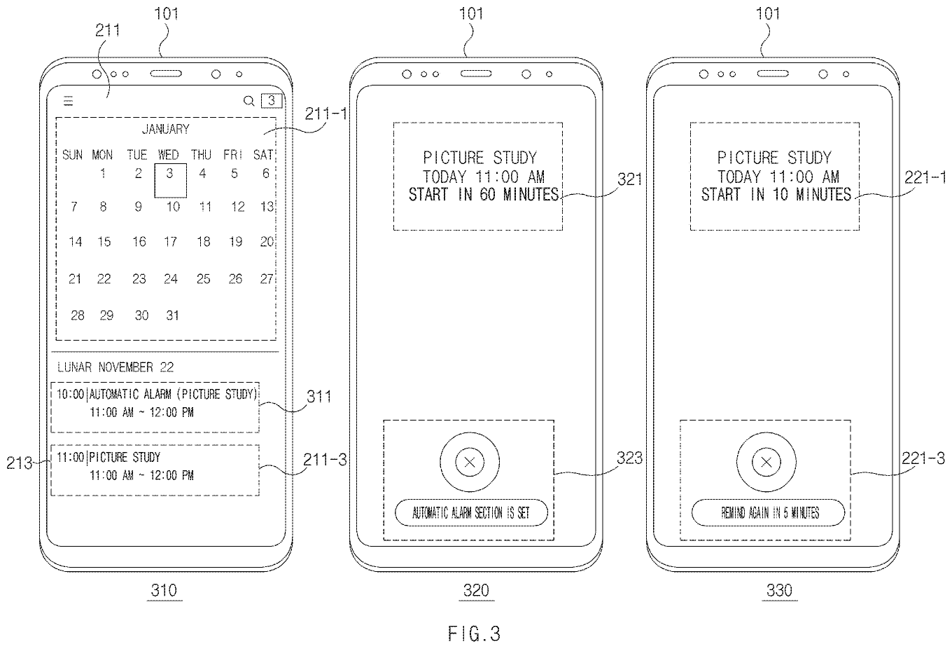

In this regard, the electronic device 101 according to various embodiments may prevent a situation where the user fails to complete the schedule by automatically generating (and/or providing) an alarm related to the start of schedule preparation based on the characteristics of the registered schedule. A detailed description of this will be provided through FIG. 3 below.

FIG. 3 is a diagram for describing an alarm function of the electronic device 101, according to an embodiment of the disclosure.

Referring to FIGS. 2 and 3, the electronic device 101 (e.g., the processor 120) according to various embodiments may automatically generate an alarm (hereinafter referred to as an “automatic alarm”) related to the initiation of schedule preparation for a registered schedule (e.g., a picture study schedule). This automatic alarm may allow a user to initiate schedule preparation.

According to various embodiments, the electronic device 101 may provide the automatic alarm based on the characteristics of the registered schedule. For example, the characteristics of the schedule may include a first characteristic related to time. The first characteristic may include the execution time (e.g., a time when the schedule starts, a time when the schedule ends, or a time during which the schedule proceeds) of the registered schedule.

According to an embodiment, the electronic device 101 may provide an automatic alarm at a time (e.g., a time corresponding to 60 minutes before the schedule execution) that precedes a first alarm occurrence time (e.g., a time corresponding to 10 minutes before the schedule execution) associated with the registered schedule, as shown in 310 of FIG. 3. In this regard, the electronic device 101 may generate an automatic alarm with a second alarm occurrence time at a time (e.g., a time corresponding to 30 minutes before the schedule execution) that precedes the first alarm occurrence time by a specified time (e.g., 20 minutes). For example, the electronic device 101 may output an automatic alarm 311, which is additionally generated in relation to the registered schedule, through the schedule list region 211-3.

According to various embodiments, the electronic device 101 may provide alarm information about the generated automatic alarm. According to an embodiment, the electronic device 101 may store the second alarm occurrence time (e.g., a time corresponding to 30 minutes prior to the schedule execution) for the registered schedule and may provide specified alarm information based on the second alarm occurrence time arrives. For example, as illustrated in 320 of FIG. 3, the electronic device 101 may output an alarm sound while outputting visual information (e.g., a schedule start in 30 minutes) 321 indicating the schedule content and the time remaining until the schedule execution time. In this regard, the electronic device 101 may provide a user interface 323 related to the release of the automatic alarm and may stop providing alarm information in response to a user input that causes the automatic alarm to be released.

According to various embodiments, the electronic device 101 may provide alarm information about the generated automatic alarm and then may provide alarm information corresponding to the first alarm time (e.g., a time corresponding to 10 minutes before the schedule execution). According to an embodiment, the electronic device 101 may provide specified alarm information based on the first alarm time arrives, as illustrated in 330 of FIG. 3.

As described above, the electronic device 101 according to various embodiments may prevent a situation in which a schedule execution is disrupted by generating an automatic alarm based on the second alarm occurrence time (e.g., 30 minutes before the schedule execution) that is a specified time (e.g., 20 minutes) earlier than the first alarm time (e.g., 10 minutes before the schedule execution). This allows the user to secure a sufficient preparation time for the schedule execution.

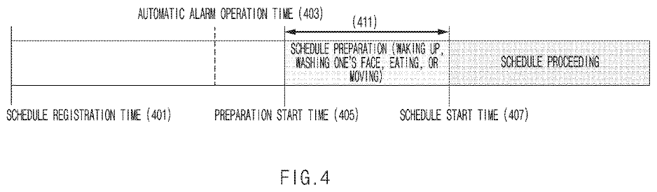

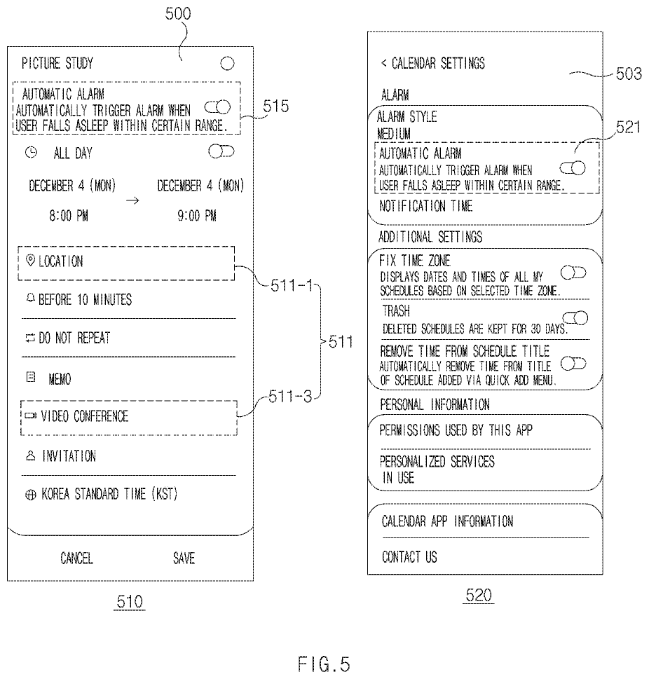

Additionally or alternatively, the electronic device 101 according to various embodiments may additionally consider a second feature related to a registered schedule when determining the second alarm occurrence time. For example, the second feature may be related to a preparation action performed by the user before the schedule is performed. The preparation action may include waking up, washing one's face, getting dressed, eating, or moving to a scheduled location. This is described in detail below with reference to FIGS. 4 and 5.

FIG. 4 is a diagram for describing an operation time of the electronic device 101, according to an embodiment of the disclosure.

FIG. 5 is a diagram for describing an automatic alarm function, according to an embodiment of the disclosure.

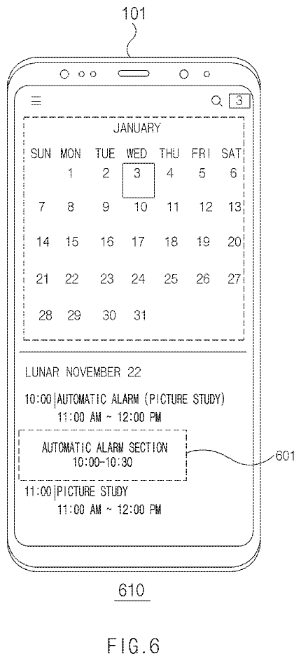

FIG. 6 is a diagram for describing an operation of providing information related to an automatic alarm operation time in the electronic device 101, according to an embodiment of the disclosure.

Referring to FIG. 4, the operation time of the electronic device 101 (e.g., the processor 120) according to various embodiments may include a schedule registration time 401 and an automatic alarm operation time 403 (e.g., an alarm occurrence time).

According to an embodiment, the schedule registration time 401 may be a time when a schedule registration operation is performed. For example, as described above through FIG. 2, a time when the schedule management screen 211 is displayed, or a time when a schedule is registered through the schedule management screen 211 may correspond to the schedule registration time 401.

According to an embodiment, the automatic alarm operation time 403 may be the time when alarm information regarding an automatic alarm is provided. For example, the second alarm occurrence time described through FIG. 3 may correspond to the automatic alarm operation time 403. According to an embodiment, the automatic alarm operation time 403 may be determined at the time of schedule registration. Also, as illustrated, the schedule registration time 401 and the automatic alarm operation time 403 may be different from each other, but various embodiments are not limited thereto. For example, the schedule registration time 401 and the automatic alarm operation time 403 may be identical to each other.

According to various embodiments, the electronic device 101 may determine the automatic alarm operation time 403 based on a preparation time 411. The preparation time 411 may be the time required for the user to complete the execution of the preparation action prior to the schedule. For example, the preparation action may include waking up, washing one's face, getting dressed, eating, or moving to a scheduled location.

According to an embodiment, the electronic device 101 may determine the preparation time based on a second feature related to the registered schedule. The second feature may be used to infer a preparation action performed by the user before the schedule is performed. For example, the electronic device 101 may use at least part (511) (e.g., a schedule execution location 511-1 and a schedule execution method 511-3) of the schedule information obtained through a schedule management screen 500 (e.g., the schedule management screen 211 of FIG. 2) as a second feature, as illustrated in 510 of FIG. 5.

For example, the electronic device 101 may determine the first time (e.g., 10 minutes) required to move to the scheduled location (e.g., a conference room) and the second time (e.g., 5 minutes) required to set up the video conference, and may use the sum of these (e.g., 15 minutes) as the preparation time 411. In this regard, the electronic device 101 according to various embodiments may determine the preparation time 411 by using an artificial intelligence (AI) model generated through machine learning. Additionally or alternatively, the electronic device 101 according to various embodiments may set the preparation time 411 based on a user input (e.g., selection), and may also set the preparation time 411 based on past data (e.g., a time required to perform past preparation actions) related to a user.

However, this is merely illustrative, and various embodiments are not limited thereto. For example, various pieces of information such as a method of moving to a schedule execution location (e.g., using public transportation) may be used as the second feature. Moreover, information (e.g., activity information (e.g., sleep information or movement information) and/or biometric information about the user) collected by an external device (e.g., a wearable device) (e.g., the electronic device 102) connected to the electronic device 101 via communication may also be used as the second feature. For example, the movement of the user getting out of bed after waking up, which is obtained by the electronic device or external device (e.g., the electronic device 102), may also be used as the second feature.

According to various embodiments, the electronic device 101 may determine a preparation start time 405 based on the preparation time 411 and determine a time earlier than the preparation start time 405 as the automatic alarm operation time 403 (e.g., a second alarm occurrence time).

According to an embodiment, the electronic device 101 may determine the preparation start time 405 as a time (e.g., 20 minutes before schedule execution), which is equal to or earlier than the preparation time 411 (e.g., 15 minutes), based on a schedule start time 407 (e.g., schedule start time). Besides, the electronic device 101 may determine the preparation start time 405 or a time earlier than the preparation start time 405 (e.g., 30 minutes before schedule execution) as the automatic alarm operation time 403.

Additionally or alternatively, in identifying the preparation time 411, the electronic device 101 according to various embodiments may determine whether an automatic alarm function is activated. For example, when the activation of the automatic alarm function is identified, the electronic device 101 may identify the preparation time 411 related to a schedule.

According to an embodiment, the automatic alarm function may be activated or deactivated via the schedule management screen 500, as illustrated in 510 of FIG. 5. For example, a user interface 515 for setting the activation or deactivation of the automatic alarm function may be displayed on the schedule management screen 500.

In this regard, based on a schedule is registered while the automatic alarm function is enabled, the electronic device 101 may perform an operation of identifying the preparation time 411 associated with the schedule. Also, based on a schedule is registered while the automatic alarm function is disabled, the electronic device 101 may exclude an operation of identifying the preparation time 411 associated with the schedule.

The operation of determining whether the automatic alarm function is enabled or disabled as described above is one embodiment, and various embodiments are not limited thereto. For example, the automatic alarm function may be enabled or disabled via an environment configuration screen 503 that defines the execution environment for the schedule function, as illustrated in 520 of FIG. 5. For example, a user interface 521 that specifies the activation or deactivation of the automatic alarm function may be displayed on the environment configuration screen 503.

Additionally or alternatively, the electronic device 101 according to various embodiments may provide the user with the automatic alarm operation time 403 determined based on the preparation time 411. For example, as illustrated in 610 of FIG. 6, the electronic device 101 may output information (e.g., an automatic alarm section) 601 related to the automatic alarm operation time 403 through the schedule list region 211-3.

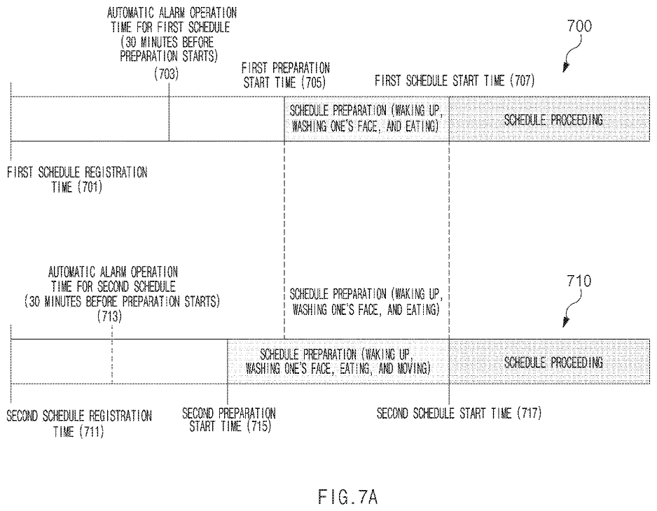

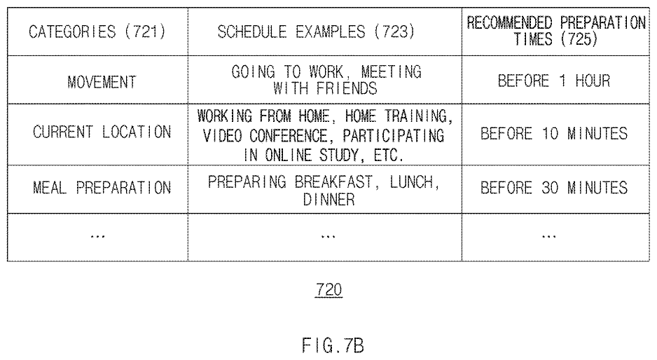

As described above, the electronic device 101 according to various embodiments may determine the automatic alarm operation time 403 based on the second feature. The second feature may be related to a preparation action performed by the user before a schedule is performed, and the preparation action performed by the user may vary depending on the characteristics of the schedule. For example, a schedule having a first characteristic may require a preparation action of a first level, and a schedule having a second characteristic may require a preparation action of a second level different from the first level. In this regard, the electronic device 101 according to various embodiments may store a preparation time corresponding to the characteristics of the schedule in advance, and then may determine the automatic alarm operation time 403 based on this. A detailed description of this will be provided through FIGS. 7A and 7B below.

FIG. 7A is a diagram for describing an operation of determining an automatic alarm operation time in the electronic device 101, according to an embodiment of the disclosure.

FIG. 7B is a diagram for describing a preparation time corresponding to a category of a schedule, according to an embodiment of the disclosure.

Referring to FIG. 7A, the electronic device 101 (e.g., the processor 120) according to various embodiments may determine an automatic alarm operation time based on a preparation action related to a registered schedule. As mentioned above, the preparation action performed by a user may vary depending on the characteristics of the schedule.

According to an embodiment, as illustrated in FIG. 7A, a first schedule 700 having the first characteristic may require a first preparation action. For example, the first schedule 700 may be a schedule performed at the current location of the electronic device 101. In this regard, waking up, washing one's face, and eating may be required as a first preparation action, whereas moving to a schedule execution location may not be required as the first preparation action.

According to an embodiment, as illustrated in FIG. 7A, a second schedule 710 having a second characteristic may require a second preparation action. For example, the second schedule 710 may be a schedule performed at a location different from the current location of the electronic device 101. In this regard, waking up, washing one's face, eating, and moving to the schedule execution location may be required as the second preparation action.

In this case, even though a registration time 701 of the first schedule 700 is the same as a registration time 711 of the second schedule 710, and a start time 707 of the first schedule 700 is substantially the same as a start time 717 of the second schedule 710, an automatic alarm operation time 703 for the first schedule 700 and an automatic alarm operation time 713 for the second schedule 710 may differ from each other.

For example, a preparation start time 715 associated with the second schedule 710 may be set at a time earlier than a preparation start time 705 associated with the first schedule 700 due to the operation of moving to the schedule execution location required by the second schedule. Accordingly, the electronic device 101 may set the automatic alarm operation time 713 associated with the second schedule 710 to a time earlier than the automatic alarm operation time 703 associated with the first schedule 700.

In this regard, the electronic device 101 according to various embodiments may distinguish between various schedules 723 based on categories 721 (or attributes), as illustrated in 720 of FIG. 7B, and may store a recommended preparation time 725 corresponding to each category 721 in advance.

For example, with respect to a first schedule (e.g., a schedule in a movement category that requires a first preparation time) that requires movement, such as going to work or an appointment with a friend, the electronic device 101 may determine a time earlier than the schedule start time by a first time (e.g., 1 hour) as the preparation start time. As in the above description, with respect to a second schedule (e.g., a schedule in the current location category that requires a second preparation time) that does not require movement, such as working from home or home training, the electronic device 101 may determine a time earlier than the schedule start time by a second time (e.g., 10 minutes) as the preparation start time. With respect to a third schedule (e.g., a schedule in the meal preparation category that requires a third preparation time) related to meal preparation, the electronic device 101 may determine a time earlier than the schedule start time by a third time (e.g., 30 minutes) as the preparation start time.

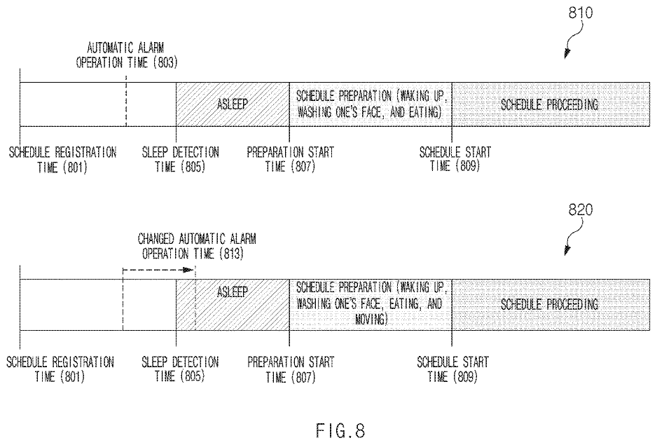

Additionally or alternatively, the electronic device 101 according to various embodiments may additionally consider whether a user is asleep when determining an automatic alarm operation time. For example, the electronic device 101 may maintain or change the automatic alarm operation time, based on whether the user is asleep. This will be described in detail with reference to FIG. 8 below.

FIG. 8 is a diagram for describing an operation of determining an automatic alarm operation time in the electronic device 101, according to an embodiment of the disclosure.

Referring to FIG. 8, the electronic device 101 (e.g., the processor 120) according to various embodiments may determine an automatic alarm operation time based on whether a user is asleep. In this regard, the electronic device 101 according to various embodiments may obtain information related to the user's sleep from an external device (e.g., the electronic device 102) or may obtain information related to the user's sleep through the sensor module 176 provided in the electronic device 101.

According to an embodiment, the electronic device 101 may determine a schedule registration time 801, a schedule start time 809, and a preparation start time 807 based on schedule information corresponding to a user input (e.g., a voice input, a touch input, a gesture input, or any combination thereof). In this regard, the description related to FIGS. 4 to 6, 7A, and 7B described above may be referenced.

According to an embodiment, the electronic device 101 may determine a sleep detection time 805 of the user based on sleep-related information obtained through an external device (e.g., the electronic device 102) or the sensor module 176 of the electronic device 101. The sleep detection time 805 may be a time, when deep sleep (i.e., Rapid Eye Movement (REM) sleep) is detected, but various embodiments are not limited thereto. For example, the electronic device 101 may determine a time, when light sleep (i.e., non-REM sleep) is detected, as the sleep detection time 805.

According to various embodiments, the electronic device 101 may determine whether the user is asleep, before providing alarm information. According to an embodiment, based on the automatic alarm operation time 803 arrives, the electronic device 101 may determine whether the user is asleep.

According to an embodiment, based on the user's sleep is not detected at the automatic alarm operation time 803 (e.g., when the user is awake), the electronic device 101 may maintain a predetermined automatic alarm operation time 803, as shown in 810 of FIG. 8. For example, the electronic device 101 may provide alarm information about an automatic alarm in response to identifying the user's wake-up state.

However, the user in a wake-up state is relatively likely to be aware of the schedule registered in the electronic device 101. Accordingly, the automatic alarm function in a situation where the user is awake may cause unnecessary alarm generation.

In this regard, based on the user's sleep is not detected at the automatic alarm operation time 803, the electronic device 101 according to various embodiments may change (813) the predetermined automatic alarm operation time 803 to a time after the time 805 when the user's sleep is detected, as shown in 820 of FIG. 8. For example, a changed automatic alarm operation time 813 may be a preparation start time or a time earlier than that time. This change in the automatic alarm operation time may prevent a situation where the user who falls asleep after the predetermined automatic alarm operation time 803 is unable to complete a registered schedule.

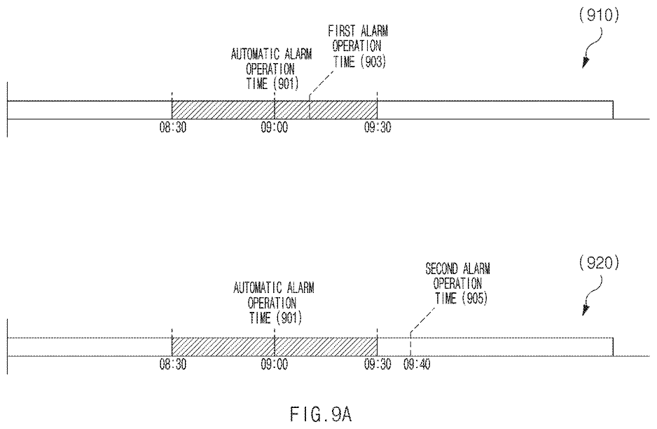

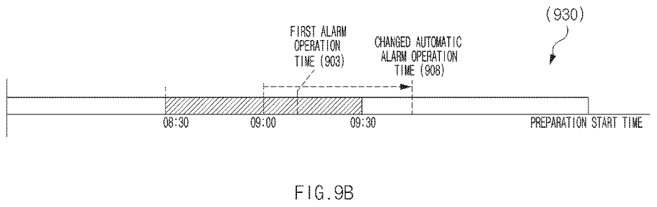

Additionally or alternatively, in determining the automatic alarm operation time, the electronic device 101 according to various embodiments may additionally consider whether there is predetermined alarm information. For example, the electronic device 101 may maintain or remove the automatic alarm operation time based on whether there is predetermined alarm information. This is described in detail below with reference to FIGS. 9A and 9B.

FIGS. 9A and 9B are drawings for describing an automatic alarm providing operation of the electronic device 101, according to various embodiments of the disclosure.

Referring to FIG. 9A, the electronic device 101 (e.g., the processor 120) according to various embodiments may determine an automatic alarm operation time based on whether there is predetermined alarm information.

According to an embodiment, based on an automatic alarm operation time 901 is determined, the electronic device 101 may determine whether there is another alarm operation time set within a specific range (e.g., ±30 minutes) based on the determined automatic alarm operation time 901.

For example, as shown in 910 of FIG. 9A, based on a first alarm operation time 903 associated with the first alarm is set within a specific range (e.g., 8:30 to 9:30) based on the automatic alarm operation time 901 (e.g., 9:00), the electronic device 101 may remove the automatic alarm operation time 901 (or the predetermined first alarm operation time 903). In other words, based on another alarm operation time is present within the specific range based on the determined automatic alarm operation time 901, the electronic device 101 may provide alarm information by using the predetermined first alarm without providing a separate automatic alarm, by excluding an operation of generating (e.g., saving or registering) the determined automatic alarm operation time.

As described above, the electronic device 101 may resolve the problem that frequent alarm information is provided unnecessarily, by excluding the generation of an automatic alarm operation time based on a predetermined other alarm operation time. In this regard, in various embodiments, excluding the generation of an automatic alarm operation time may be interpreted to mean stopping, temporarily pausing, refraining from, or limiting the generation of the automatic alarm operation time.

As another example, as in 920 of FIG. 9A, based on a second alarm operation time 905 related to a second alarm is set outside the specific range (e.g., 9:40) based on the automatic alarm operation time 901, the electronic device 101 may maintain the automatic alarm operation time 901. In other words, the electronic device 101 may generate an automatic alarm separately from the predetermined second alarm to provide alarm information.

Additionally or alternatively, according to various embodiments, based on the first alarm operation time 903 is set within the specific range based on the automatic alarm operation time 901, as shown in 930 of FIG. 9B, the electronic device 101 may change the automatic alarm operation time to another time without removing the automatic alarm operation time. For example, the electronic device 101 may change the automatic alarm operation time 901 to another time 908 outside the specific range (e.g., 30 minutes before or after the first alarm operation time 903).

As described above, according to various embodiments, based on the automatic alarm operation time 901 is determined, the electronic device 101 may identify the existence of another alarm operation time and may remove, maintain, or change the automatic alarm operation time 901 determined based on this. However, this is merely illustrative, and various embodiments are not limited thereto. According to various embodiments, the electronic device 101 may identify the existence of other alarm operation times 901 at various times before the automatic alarm is provided (e.g., output), and may remove, maintain, or change the automatic alarm operation time 901 determined based on the identified result to another time.

According to an embodiment, based on receiving a user input for registering schedule information, the electronic device 101 may determine whether there are other alarm operation times set within the specific range (e.g., ±30 minutes) based on the determined automatic alarm operation time 901. According to an embodiment, based on user sleep is detected, the electronic device 101 may determine whether there is another alarm operation time set within a specific range (e.g., ±30 minutes) based on the determined automatic alarm operation time 901. According to an embodiment, based on the stored automatic alarm operation time arrives, the electronic device 101 may determine whether there is another alarm operation time set within the specific range (e.g., ±30 minutes), based on the determined automatic alarm operation time 901.

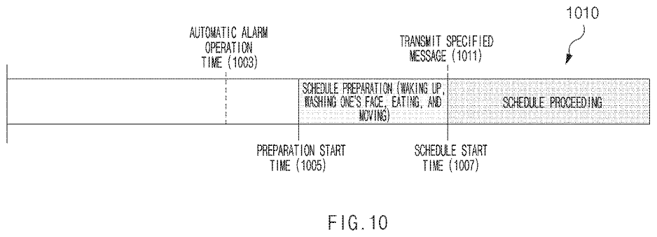

FIG. 10 is a diagram for describing an automatic alarm operation of the electronic device 101, according to an embodiment of the disclosure.

Referring to FIG. 10, the electronic device 101 (e.g., the processor 120) according to various embodiments may determine whether a user is capable of fulfilling a schedule, based on activity information (e.g., sleep information or movement information) and/or biometric information related to a user, and based on this, may transmit a specified message to at least one other electronic device (e.g., the electronic device 104) related to the schedule. For example, based on a user's state where he/she is unable to fulfill a schedule is detected, the electronic device 101 may deliver a situation where he/she has difficulty in participating in a schedule due to personal circumstances, by transmitting a specified message.

According to an embodiment, as illustrated in 1010 of FIG. 10, the electronic device 101 may provide specified alarm information based on an automatic alarm operation time 1003 arrives. Moreover, after providing specified alarm information, the electronic device 101 may continuously or periodically monitor the user's status.

In this regard, the electronic device 101 may determine whether the user may fulfill the schedule, based on the monitoring results up to a preparation start time 1005. For example, based on the preparation start time 1005 has arrived but the user is still detected to be asleep, the electronic device 101 may determine that the user is unable to fulfill the schedule.

According to various embodiments, the electronic device 101 may send a specified message to at least one other electronic device (e.g., the electronic device 104) related to the schedule in response to the determination that the user is unable to fulfill the schedule. In this regard, according to various embodiments, the electronic device 101 may identify at least one other electronic device related to the schedule based on at least part of schedule information (e.g., schedule personnel) obtained from a schedule registration operation.

Additionally or alternatively, according to various embodiments, the electronic device 101 may withhold the transmission of a specified message until a schedule start time 1007. This may allow the user to directly compose a message regarding non-participation in the schedule based on the user wakes up before the schedule start time 1007. In this regard, based on the electronic device 101 does not detect the user's wake-up or does not detect the transmission of a message by the user until the schedule start time 1007, the electronic device 101 may perform (1011) the action of transmitting a specified message.

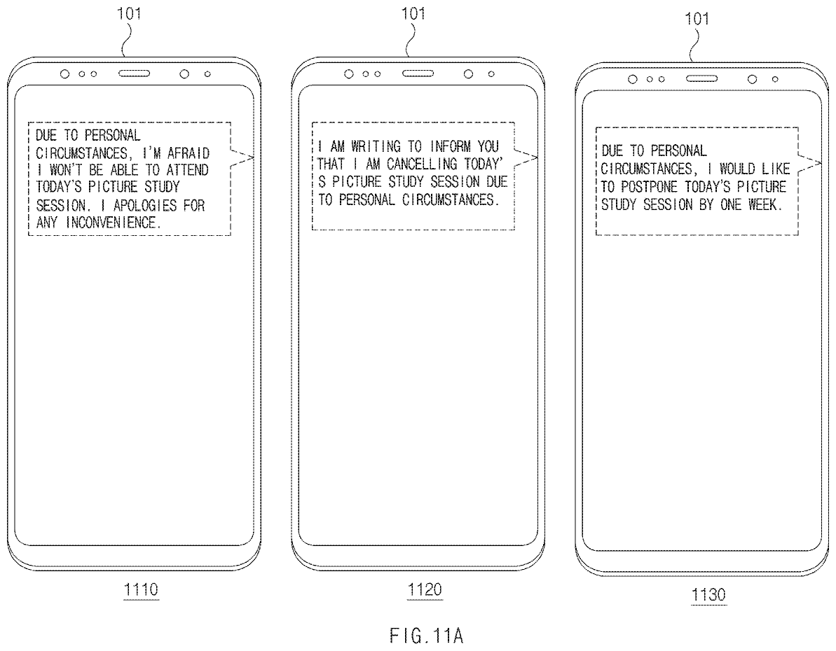

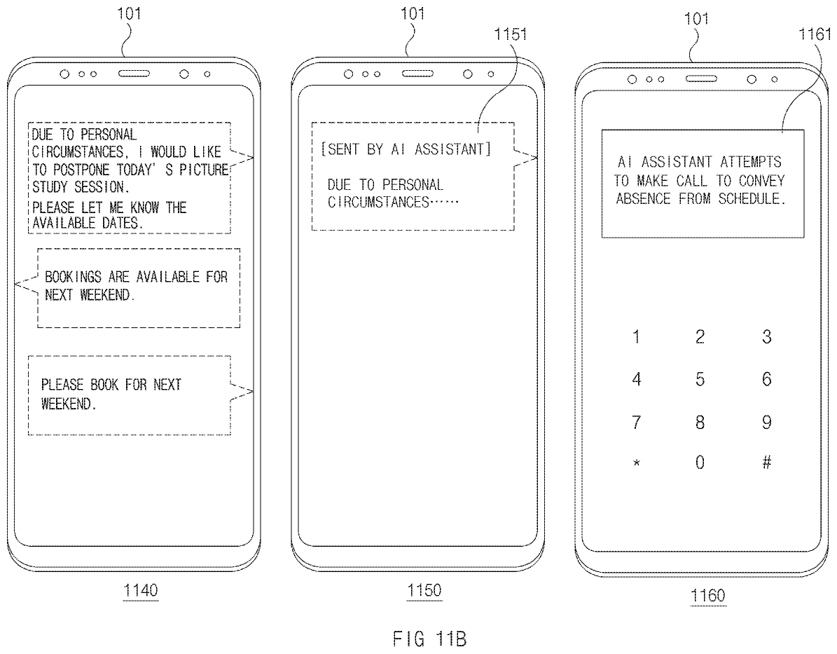

FIGS. 11A and 11B are drawings for describing messages related to schedule non-attendance, according to various embodiments of the disclosure.

Referring to FIG. 11A, the electronic device 101 according to various embodiments may deliver a situation where a user has difficulty participating in a schedule due to personal circumstances, by transmitting a specified message, as described above.

In this regard, the electronic device 101 according to various embodiments may transmit messages with different pieces of content depending on the importance of the registered schedule.

According to an embodiment, based on the registered schedule has a first importance that is relatively low (e.g., a schedule in which a user attends as an observer rather than a host), the electronic device 101 may transmit a first message for providing a notification of non-attendance at a scheduled event (e.g., ‘I am unable to attend the event due to personal circumstances’), as illustrated in 1110 of FIG. 11A. This first message may allow the schedule to proceed with the remaining persons excluding the user.

According to an embodiment, based on the registered schedule has a second importance higher than the first importance (e.g., a schedule in which a user attends as a voting participant), the electronic device 101 may transmit a second message for inducing schedule cancellation (e.g., I would like to cancel the schedule due to personal circumstances), as illustrated in 1120 of FIG. 11A. This second message may induce the cancellation of the current schedule and the rescheduling of a future schedule.

According to an embodiment, based on the registered schedule has a third importance higher than the second importance (e.g., a schedule in which a user attends as a host), the electronic device 101 may transmit a third message (e.g., Due to personal circumstances, I would like to postpone the schedule by one week.) for inducing schedule postponement, as illustrated in 1130 of FIG. 11A. This third message may allow the user to immediately plan another schedule along with the cancellation of the current schedule.

Additionally or alternatively, according to various embodiments, based on detecting that a user is unable to fulfill the schedule, the electronic device 101 may attempt to change the schedule by transmitting a message in a conversational format. According to an embodiment, the electronic device 101 may request at least one other electronic device related to the schedule to change a schedule, as illustrated in 1140 of FIG. 11B, and may obtain a date on which a schedule change is possible in response to thereto. Moreover, the electronic device 101 may attempt to change the schedule based on a date, which does not overlap the previously registered schedule, among dates obtained in response.

Additionally or alternatively, according to various embodiments, the electronic device 101 may apply visual effects related to the sender of the message to a message regarding the non-attendance at a scheduled event. According to an embodiment, based on a specified message stored in the electronic device 101 is transmitted, the electronic device 101 may apply a visual effect (e.g., [Sent by AI Assistant]) at the beginning of the message indicating that the sender is the electronic device 101, as illustrated in 1150 of FIG. 11B. Additionally, based on a message written directly by the user is transmitted, the electronic device 101 may apply a visual effect (1151) (e.g., [Sent by User]) at the beginning of the message indicating that the sender is the user.

Additionally or alternatively, according to various embodiments, the electronic device 101 may apply a visual effect related to the user's status to a message regarding schedule non-attendance. According to an embodiment, based on the user is detected to be sleeping by the time the message regarding non-attendance is transmitted, the electronic device 101 may provide a visual effect corresponding to the user's sleeping state (e.g., [user sleeping]) at the beginning of the message regarding the schedule non-attendance. Furthermore, the electronic device 101 may identify the user's health status at the time the message regarding non-attendance is transmitted. In this regard, based on a health abnormality of the user is detected at the time the message regarding non-attendance is transmitted, the electronic device 101 may provide a visual effect corresponding to the user's health abnormality (e.g., [user health abnormality]) at the beginning of the message regarding the schedule non-attendance.

Additionally or alternatively, the electronic device 101 according to various embodiments may provide a notification of the schedule non-attendance by using an automatic telephone connection. According to an embodiment, as shown in 1160 of FIG. 11B, the electronic device 101 may attempt to make a phone call (1161) to notify at least one other electronic device (e.g., the electronic device 104) related to the schedule of non-attendance or to proceed with changing the schedule through an AI assistant.

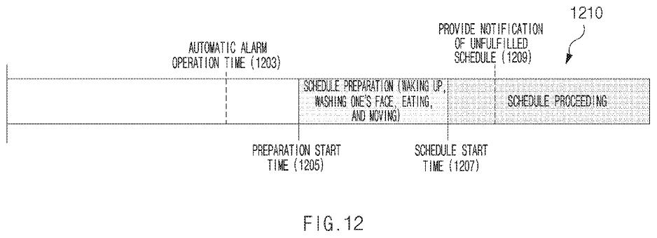

FIG. 12 is a diagram for describing an automatic alarm operation of the electronic device 101, according to an embodiment of the disclosure.

Referring to FIG. 12, the electronic device 101 (e.g., the processor 120) according to various embodiments may determine whether a user wakes up, based on activity information (e.g., sleep information or movement information) related to the user and/or biometric information, and may notify the user of unfulfilled schedules based on this, as illustrated in 1210. For example, based on detecting that the user has woken up and has not participated in a schedule, the electronic device 101 may notify the user of the unfulfilled schedule.

According to an embodiment, the electronic device 101 may provide specified alarm information based on an automatic alarm operation time 1203 arrives, as described above. Moreover, after providing specified alarm information, the electronic device 101 may continuously or periodically monitor the user's status.

In this regard, the electronic device 101 may detect the user's waking based on the monitoring results. For example, based on the user's waking is detected after a schedule start time 1207, the electronic device 101 may notify the user of an unfulfilled schedule (1209). However, this is merely illustrative, and various embodiments are not limited thereto. For example, the electronic device 101 may notify the user of the unfulfilled schedule even before the schedule start time 1207 arrives (or after a preparation start time 1205).

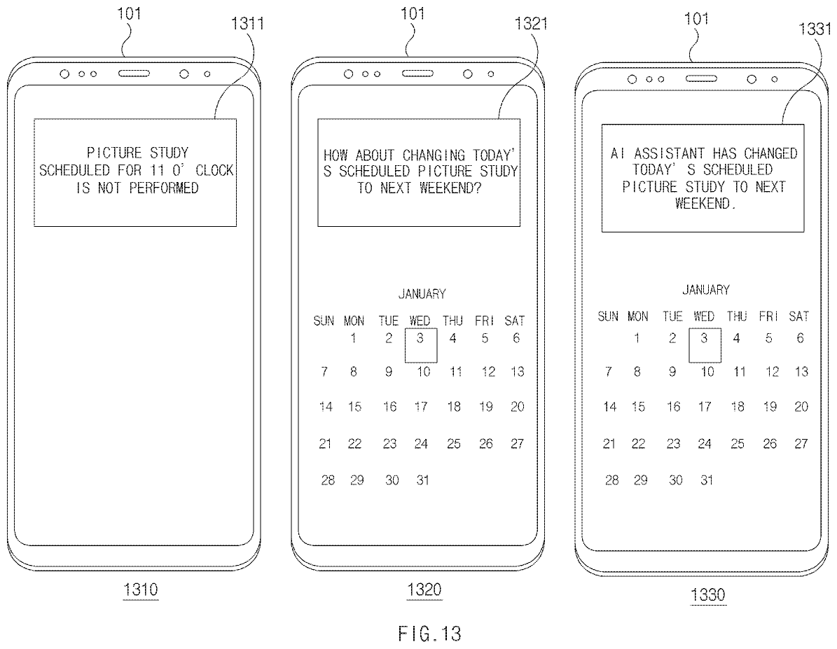

FIG. 13 is a diagram for describing a notification related to an unfulfilled schedule, according to an embodiment of the disclosure.

Referring to FIG. 13, as described above, based on detecting that a user has woken up after missing a scheduled event due to sleep, the electronic device 101 according to various embodiments may notify a user of an unfulfilled schedule, in which was not participated.

In this regard, the electronic device 101 according to various embodiments may provide notifications of different pieces of content depending on the importance of the registered schedule.

According to an embodiment, based on the registered schedule has a first importance that is relatively low, the electronic device 101 may provide a first notification 1311 indicating the existence of an unfulfilled schedule, as illustrated in 1310 of FIG. 13.

According to an embodiment, based on the registered schedule has a second importance higher than the first importance, the electronic device 101 may provide a second notice 1321 that induces a postponement of the unfulfilled schedule, as illustrated in 1320 of FIG. 13.

According to an embodiment, based on the registered schedule has a third importance higher than the second importance, the electronic device 101 may provide a third notice 1331 indicating that the unfulfilled schedule is postponed, as illustrated in 1330 of FIG. 13. In this regard, the electronic device 101 may perform a schedule change for the unfulfilled schedule before providing the third notice.

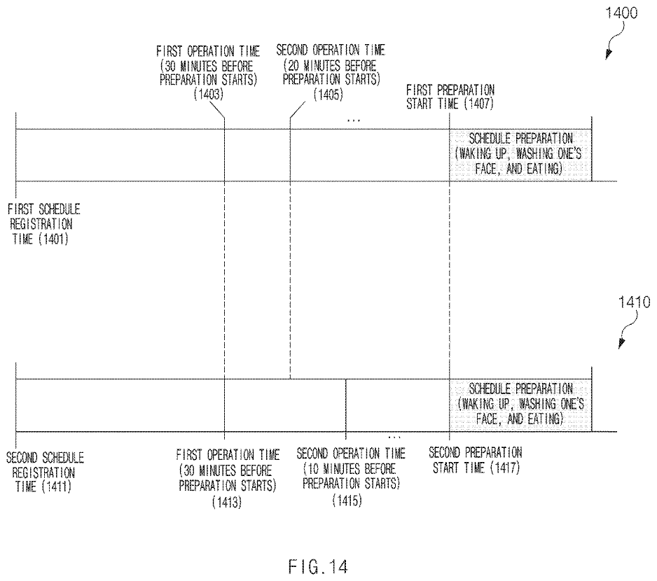

FIG. 14 is a diagram for describing an automatic alarm operation of the electronic device 101, according to an embodiment of the disclosure.

Referring to FIG. 14, the electronic device 101 (e.g., the processor 120) according to various embodiments may vary the provision period of an automatic alarm based on the importance of the registered schedule.

According to an embodiment, even when a registration time 1401 of a first schedule 1400 is the same as a registration time 1411 of a second schedule 1410, and a start time 1407 of the first schedule 1400 is substantially the same as a start time 1417 of the second schedule 1410, a period (e.g., the occurrence period of the automatic alarm) at which the automatic alarm is provided for the first schedule 1400 may be different from a period at which the automatic alarm is provided for the second schedule 1410.

For example, based on the first schedule 1400 with first importance, which is relatively high, is registered, the electronic device 101 may provide an automatic alarm based on a first period (e.g., a 10-minute period). For example, the electronic device 101 may provide a first automatic alarm at a first operation time 1403 (e.g., 30 minutes before preparation begins) and a second automatic alarm at a second operation time 1405 (e.g., 20 minutes before preparation begins) corresponding to the first period interval.

Moreover, based on the second schedule 1410 with a second importance, which is relatively low, is registered, the electronic device 101 may provide an automatic alarm based on a second period (e.g., a 20-minute period) longer than the first period. For example, the electronic device 101 may provide the first automatic alarm at a first operation time 1413 (e.g., 30 minutes before preparation begins) and a second automatic alarm at a second operation time 1415 (e.g., 10 minutes before preparation begins) corresponding to the second period interval.

FIG. 14 illustrates that the first operation time 1403 for the first schedule 1400 having the relatively-high first importance is the same (e.g., 30 minutes before preparation begins) as the first operation time 1413 for the second schedule 1410 having the relatively-low second importance. However, the first operation time 1403 for the first schedule 1400 and the first operation time 1413 for the second schedule 1410 may vary depending on the importance. For example, the electronic device 101 may set the first operation time 1403 for the first schedule 1400 having the relatively-high first importance to a time earlier than the first operation time 1413 for the second schedule 1410 having a relatively-low second importance.

Additionally or alternatively, according to various embodiments, the electronic device 101 may vary the intensity of the automatic alarm based on the importance of the registered schedule.

For example, based on the first schedule 1400 having the relatively-high first importance is registered, the electronic device 101 may provide an automatic alarm based on first occurrence intensity.

In addition, based on the second schedule 1410 having the relatively-low second importance is registered, the electronic device 101 may provide an automatic alarm based on second occurrence intensity smaller than the first occurrence intensity.

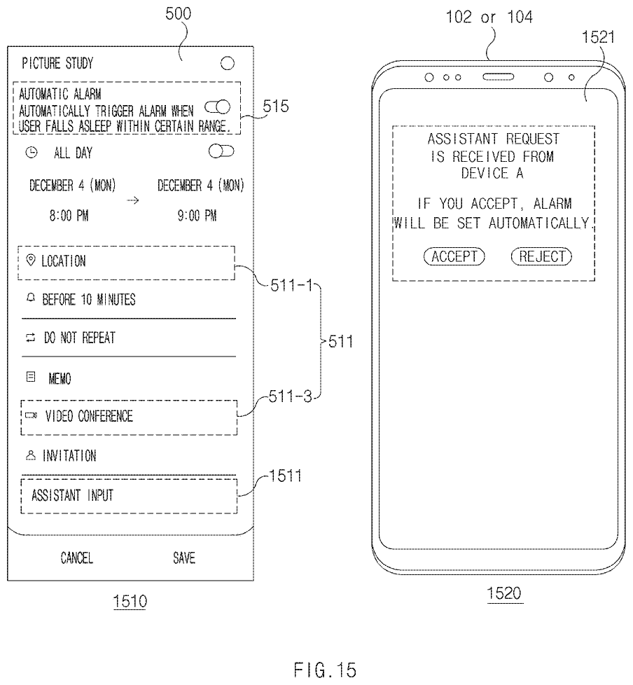

FIG. 15 is a diagram for describing an automatic alarm operation of the electronic device 101, according to an embodiment of the disclosure.

Referring to FIG. 15, in providing an automatic alarm, the electronic device 101 (e.g., the processor 120) according to various embodiments may support collaboration with an assistant. According to an embodiment, the collaboration with an assistant may be a function of delivering an automatic alarm to another electronic device 102 and/or 104 designated as the assistant. Through the collaboration with an assistant, the automatic alarm may also be provided through the other electronic device 102 and/or 104 designated as the assistant, thereby helping the assistant to help the user become aware of the schedule registered on the electronic device 101.

In this regard, the electronic device 101 may obtain information (e.g., device information, phone number, or email information) related to the assistant through the schedule management screen 500 (e.g., the schedule management screen 211 of FIG. 2), as illustrated in 1510 of FIG. 15. For example, the schedule management screen 500 may display a user interface 1511 for inputting information about the automatic assistant.

Moreover, the other electronic device 102 and/or 104 specified as the assistant may provide a user interface 1521 for specifying whether to register the automatic alarm provided by the electronic device 101, as shown in 1520 of FIG. 15. Accordingly, the other electronic device 102 and/or 104 may accept or reject the registration of the provided automatic alarm based on a user input. For example, based on the registration of the automatic alarm is accepted, the other electronic device 102 and/or 104 may register the automatic alarm internally and may provide alarm information based on the alarm occurrence time associated with the automatic alarm arrives.

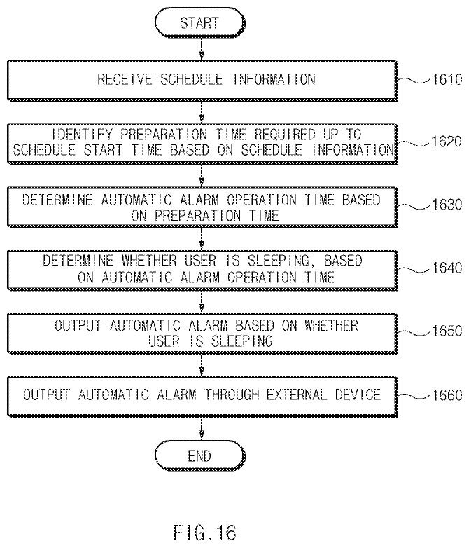

FIG. 16 is a flowchart for describing an operation of the electronic device 101, according to an embodiment of the disclosure. Moreover, each operation in the following embodiments may be sequentially performed, but is not necessarily sequentially performed. For example, the order of operations may be changed, and at least two operations may be performed in parallel. Also, at least one of the above-described operations may be omitted according to an embodiment.

Referring to FIG. 16, in operation 1610, the electronic device 101 (e.g., the processor 120) according to various embodiments may receive schedule information. The schedule information may include schedule content (e.g., a schedule title), a schedule execution time (e.g., a schedule start time), a schedule execution location (e.g., a company), a schedule execution method (e.g., a video conference), schedule stakeholders (e.g., meeting attendees), a method of moving to the schedule execution location (e.g., using public transportation), or any combination thereof. According to an embodiment, the electronic device 101 may receive schedule information based on a voice input, a touch input, a gesture input, or any combination thereof. For example, the electronic device 101 may register a schedule corresponding to the schedule information. According to an embodiment, the schedule may be stored inside the electronic device 101 (e.g., the memory 130) or outside the electronic device 101 (e.g., the electronic device 104).

According to various embodiments, in operation 1620, the electronic device 101 (e.g., the processor 120) may identify the preparation time 411 required up to the schedule start time 407 based on the schedule information. The preparation time 411 may be the time required for the user to complete the execution of the preparation action prior to the schedule. For example, the preparation action may include waking up, washing one's face, getting dressed, eating, or moving to a scheduled location.

According to various embodiments, in operation 1630, the electronic device 101 (e.g., the processor 120) may determine the automatic alarm operation time 403 based on the preparation time 411. According to an embodiment, the electronic device 101 may determine the preparation start time 405 based on the preparation time 411 and determine a time earlier than the preparation start time 405 as the automatic alarm operation time 403.

According to various embodiments, in operation 1640, the electronic device 101 (e.g., the processor 120) may determine whether a user is sleeping, based on the automatic alarm operation time 403. According to an embodiment, based on the automatic alarm operation time 403 arrives, the electronic device 101 may determine whether the user is sleeping based on information (e.g., movement information and/or biometric information) collected through the sensor module 176. Additionally or alternatively, according to various embodiments, the electronic device 101 may obtain information indicating whether the user is sleeping or data used to determine whether the user is sleeping, from an external device (e.g., a wearable device) (e.g., the electronic device 102) connected to the electronic device 101 via communication.

According to various embodiments, in operation 1650, the electronic device 101 (e.g., the processor 120) may output an automatic alarm based on whether the user is sleeping. According to an embodiment, based on the state of a sleeping user is identified at the automatic alarm operation time 403, the electronic device 101 may output an automatic alarm.

According to various embodiments, in operation 1660, the electronic device 101 (e.g., the processor 120) may output the automatic alarm through an external device (e.g., the electronic device 102). For example, the electronic device 101 may output an automatic alarm through the external device as well as the electronic device 101 to enhance the alarm effect for the registered schedule. According to an embodiment, based on the electronic device 101 outputs an automatic alarm and a specified time has arrived but the user's waking is not detected, the electronic device 101 may output the automatic alarm through the external device.

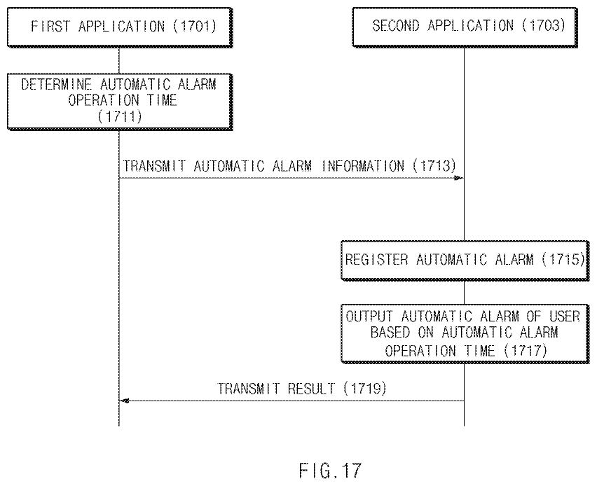

FIG. 17 is a flowchart for describing an operation of the electronic device 101, according to an embodiment of the disclosure.

Moreover, each operation in the following embodiments may be sequentially performed, but is not necessarily sequentially performed. For example, the order of operations may be changed, and at least two operations may be performed in parallel. Also, at least one of the above-described operations may be omitted according to an embodiment.

Referring to FIG. 17, the electronic device 101 according to various embodiments may include a first application 1701 and a second application 1703. According to an embodiment, the first application 1701 may be an application that supports schedule management (e.g., a schedule management application), and the second application 1703 may be an application that supports an alarm function (e.g., an alarm application).

According to various embodiments, in operation 1711, the first application 1701 may determine the automatic alarm operation time 403. According to an embodiment, the operation of determining the automatic alarm operation time 403 may include operations 1610 to 1630 of FIG. 16.

According to various embodiments, in operation 1713, the first application 1701 may transmit automatic alarm information to the second application 1703. According to an embodiment, the automatic alarm information may include the automatic alarm operation time 403.

According to various embodiments, in operation 1715, the second application 1703 may register an automatic alarm based on the automatic alarm information. For example, the second application 1703 may register the automatic alarm operation time 403.

According to various embodiments, in operation 1717, the second application 1703 may output an automatic alarm based on the automatic alarm operation time 403. According to an embodiment, based on the automatic alarm operation time 403 arrives, the second application 1703 may provide alarm information (e.g., visual alarm information, auditory alarm information, tactile alarm information, or any combination thereof) about a schedule registered in the first application 1701.

According to various embodiments, in operation 1719, the second application 1703 may provide an output result for the automatic alarm to the first application 1701. For example, the second application 1703 may provide a result indicating whether the automatic alarm operation was performed normally.

As described above, the automatic alarm function according to various embodiments may be provided by the collaboration of the first application 1701 and the second application 1703. However, this is merely illustrative, and various embodiments are not limited thereto. For example, the automatic alarm function according to various embodiments may be provided by the standalone operation of the first application 1701 (or the second application 1703).

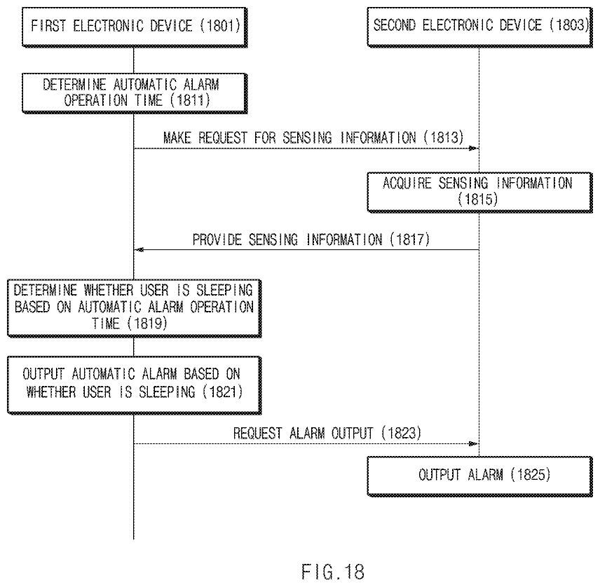

FIG. 18 is a flowchart for describing the operation of an automatic alarm system, according to an embodiment of the disclosure.

Moreover, each operation in the following embodiments may be sequentially performed, but is not necessarily sequentially performed. For example, the order of operations may be changed, and at least two operations may be performed in parallel. Also, at least one of the above-described operations may be omitted according to an embodiment.

Referring to FIG. 18, an automatic alarm system according to various embodiments may be composed of a first electronic device 1801 (e.g., the electronic device 101) and a second electronic device 1803 (e.g., the electronic device 102). For example, the second electronic device 1803 may be a wearable device that may be worn on a user's body.

According to various embodiments, in operation 1811, the first electronic device 1801 may determine the automatic alarm operation time 403. According to an embodiment, the operation of determining the automatic alarm operation time 403 may include operations 1610 to 1630 of FIG. 16.

According to various embodiments, in operation 1813, the first electronic device 1801 may make a request for sensing information to the second electronic device 1803.

According to various embodiments, in operation 1815, the second electronic device 1803 may acquire the sensing information by using at least one sensor module. According to an embodiment, the sensing information may include movement information and/or biometric information related to a user.

According to various embodiments, in operation 1817, the second electronic device 1803 may provide the sensing information to the first electronic device 1801.

According to various embodiments, in operation 1819, the first electronic device 1801 may determine whether the user is sleeping based on the automatic alarm operation time 403. According to an embodiment, based on the automatic alarm operation time 403 arrives, the first electronic device 1801 may determine whether the user is sleeping based on the sensing information.

According to various embodiments, in operation 1821, the first electronic device 1801 may output an automatic alarm based on whether the user is sleeping. According to an embodiment, based on the state of a sleeping user is identified at the automatic alarm operation time 403, the first electronic device 1801 may output the automatic alarm.

According to various embodiments, in operation 1823, the first electronic device 1801 may request the second electronic device 1803 to output an alarm. For example, the first electronic device 1801 may also output the automatic alarm through the second electronic device 1803 to enhance the alarm effect for a registered schedule.

According to various embodiments, in operation 1825, the second electronic device 1803 may request the output of an alarm in response to the request from the first electronic device 1801.

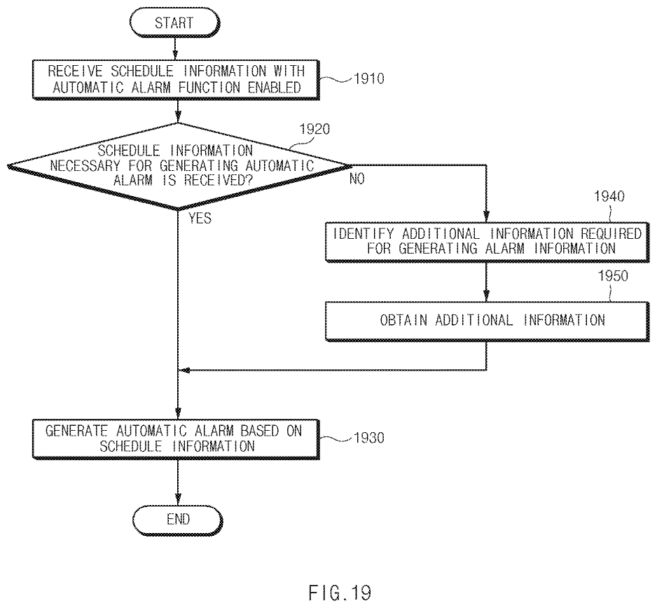

FIG. 19 is a flowchart for describing an operation of the electronic device 101, according to an embodiments of the disclosure.

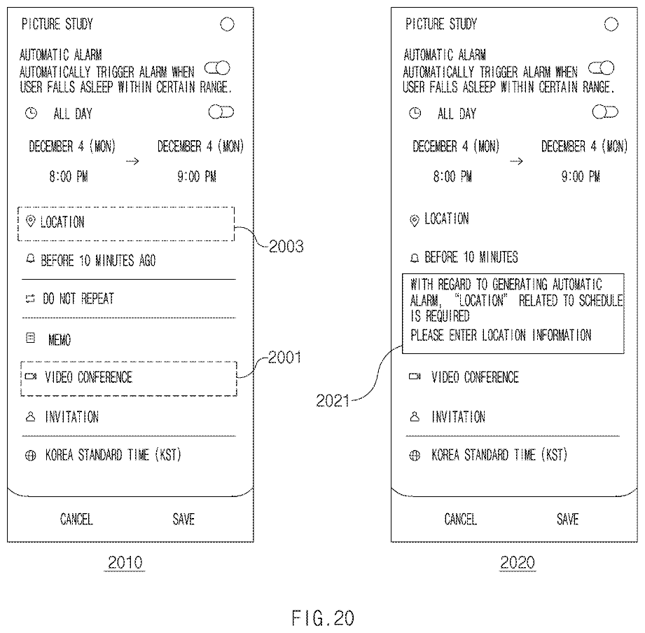

FIG. 20 is a diagram for describing a schedule registration operation, according to an embodiment of the disclosure.

Moreover, each operation in the following embodiments may be sequentially performed, but is not necessarily sequentially performed. For example, the order of operations may be changed, and at least two operations may be performed in parallel. Also, at least one of the above-described operations may be omitted according to an embodiment.

Referring to FIG. 19, in operation 1910, the electronic device 101 (e.g., the processor 120) according to various embodiments may receive schedule information with an automatic alarm function enabled. The schedule information may include schedule content (e.g., a schedule title), a schedule execution time (e.g., a schedule start time), a schedule execution location (e.g., a company), a schedule execution method (e.g., a video conference), schedule stakeholders (e.g., meeting attendees), a method of moving to the schedule execution location (e.g., using public transportation), or any combination thereof. According to an embodiment, the electronic device 101 may receive schedule information based on a voice input, a touch input, a gesture input, or any combination thereof.

According to various embodiments, in operation 1920, the electronic device 101 (e.g., the processor 120) may determine whether schedule information necessary for generating an automatic alarm is received. According to an embodiment, the electronic device 101 may determine whether schedule information at a level sufficient to infer the time, at which the schedule is to be performed, has been received. Besides, the electronic device 101 may determine whether schedule information at a level sufficient to infer a preparation action performed by the user before the schedule is to be performed has been received.

According to various embodiments, based on determining that schedule information necessary for generating an automatic alarm has been received, in operation 1930, the electronic device 101 (e.g., the processor 120) may generate an automatic alarm based on the schedule information.

According to various embodiments, based on determining that schedule information required for generating automatic alarm has not been received, in operation 1940, the electronic device 101 (e.g., the processor 120) may identify additional information required for generating alarm information. According to an embodiment, as illustrated in 2010 of FIG. 20, based on schedule information, in which only a schedule execution method (e.g., video conferencing) 2001 is specified, is received, the electronic device 101 may determine that location information 2003 is additionally required in generating alarm information.

According to various embodiments, based on the additional information required for generating alarm information is identified, in operation 1950, the electronic device 101 (e.g., the processor 120) may obtain the additional information. According to an embodiment, as shown in 2020 of FIG. 20, the electronic device 101 may obtain the additional information by providing guide information 2021 that induces an input for the additional information (e.g., location information).

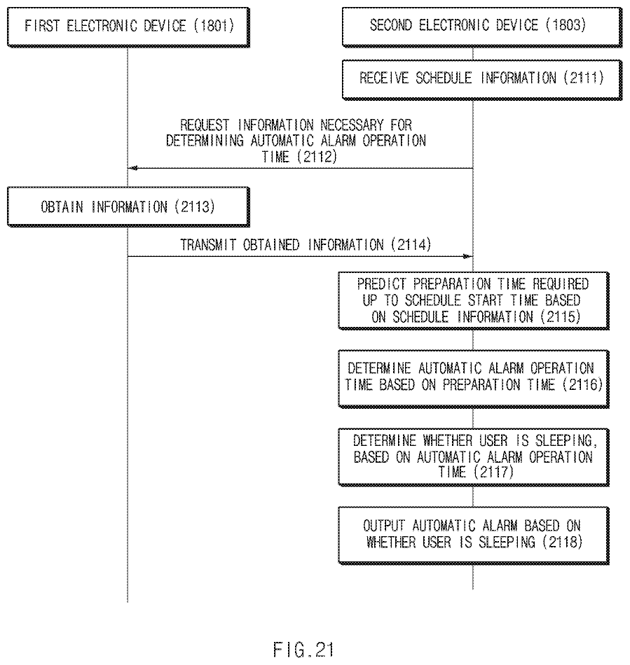

FIG. 21 is a flowchart for describing an operation of an automatic alarm system, according to an embodiment of the disclosure.

Moreover, each operation in the following embodiments may be sequentially performed, but is not necessarily sequentially performed. For example, the order of operations may be changed, and at least two operations may be performed in parallel. Also, at least one of the above-described operations may be omitted according to an embodiment.

Referring to FIG. 21, an automatic alarm system according to various embodiments may be composed of the first electronic device 1801 (e.g., the electronic device 101) and the second electronic device 1803 (e.g., the electronic device 102). For example, the second electronic device 1803 may be a wearable device that may be worn on a user's body.

According to various embodiments, in operation 2111, the second electronic device 1803 may receive schedule information. The schedule information may include schedule content (e.g., a schedule title), a schedule execution time (e.g., a schedule start time), a schedule execution location (e.g., a company), a schedule execution method (e.g., a video conference), schedule stakeholders (e.g., meeting attendees), a method of moving to the schedule execution location (e.g., using public transportation), or any combination thereof. According to an embodiment, the second electronic device 1803 may receive schedule information based on a voice input, a touch input, a gesture input, or any combination thereof.

According to various embodiments, in operation 2115, the second electronic device 1803 may predict the preparation time 411 required up to the schedule start time 407 based on schedule information. The preparation time 411 may be the time required for the user to complete the execution of the preparation action prior to the schedule. For example, the preparation action may include waking up, washing one's face, getting dressed, eating, or moving to a scheduled location.

According to various embodiments, in operation 2116, the second electronic device 1803 may determine the automatic alarm operation time 403 based on the preparation time 411. According to an embodiment, the second electronic device 1803 may identify the preparation start time 405 based on the preparation time 411 and may determine a time earlier than the preparation start time 405 as the automatic alarm operation time 403.

According to various embodiments, in operation 2117, the second electronic device 1803 may determine whether a user is sleeping, based on the automatic alarm operation time 403. According to an embodiment, based on the automatic alarm operation time 403 arrives, the second electronic device 1803 may determine whether the user is sleeping based on information (e.g., movement information and/or biometric information) collected through a sensor module.

According to various embodiments, in operation 2118, the second electronic device 1803 may output an automatic alarm based on whether the user is sleeping. According to an embodiment, based on the state of a sleeping user is identified at the automatic alarm operation time 403, the second electronic device 1803 may output the automatic alarm.

Additionally or alternatively, according to various embodiments, the second electronic device 1803 may obtain information necessary for determining an automatic alarm operation time from an external source.

According to an embodiment, in operation 2112, the second electronic device 1803 may request information necessary for determining the automatic alarm operation time from the first electronic device 1801 (or an external server). According to an embodiment, the second electronic device 1803 may request at least some of information necessary for predicting the user's preparation time, and information necessary to determine whether there is another alarm operation time set within a specific range (e.g., ±30 minutes) based on the automatic alarm operation time 901.

In this regard, in operation 2113, the first electronic device 1801 (or an external server) according to various embodiments may obtain information corresponding to the request of the second electronic device from the stored information. Moreover, in operation 2114, the first electronic device 1801 (or external server) according to various embodiments may provide the obtained information to the second electronic device 1803.

The electronic device 101 according to various embodiments may include the communication module 190 (e.g., the at least one communication module 190) that establishes communication with the external device 102, the processor 120 (e.g., the at least one processor 120) including processing circuitry, and the memory 130 (e.g., the at least one memory 130) including one or more storage media. According to an embodiment, the one or more storage media may store instructions that, when executed by the at least one processor 120 individually or collectively, cause the electronic device 101 to obtain schedule information based on a user input, to determine the start time 407 associated with a schedule based on at least part of the schedule information, to set a preparation time for generating of an automatic alarm generation based on the start time 407, to determine whether a sleep state of a user is maintained using information received through the communication module 190 in response to arrival of the preparation time, to determine the alarm occurrence time 403 of the automatic alarm based on the at least part of the schedule information in response to determining that the sleep state of the user is maintained, and to generate the automatic alarm based on the alarm occurrence time 403 of the automatic alarm.

According to various embodiments, the one or more storage media may store instructions that, when executed by the at least one processor 120 individually or collectively, cause the electronic device 101 to determine whether the sleep state of the user is maintained using information received through the communication module 190 in response to arrival of the start time 407 associated with a schedule after generating the automatic alarm, to determine at least one other electronic device 104 based on the at least part of the schedule information when as a result of using the received information, it is identified that the user is sleeping, and to transmit a specified message to the determined at least one other electronic device 104.

According to various embodiments, the one or more storage media may store instructions that, when executed by the at least one processor 120 individually or collectively, cause the electronic device 101 to determine a category of the schedule based on the at least part of the schedule information, to determine a first time as the alarm occurrence time 403 of the automatic alarm based on a first category requiring a first preparation time is identified, and to determine a second time earlier than the first time as the alarm occurrence time 403 of the automatic alarm based on a second category requiring a second preparation time greater than the first preparation time is identified.

According to various embodiments, the one or more storage media may store instructions that, when executed by the at least one processor 120 individually or collectively, cause the electronic device 101 to determine an importance of the schedule based on the at least part of the schedule information, to determine a first time as the alarm occurrence time 403 of the automatic alarm based on a first importance is identified, and to determine a second time earlier than the first time as the alarm occurrence time 403 of the automatic alarm based on a second importance greater than the first importance is identified.

According to various embodiments, the one or more storage media may store instructions that, when executed by the at least one processor 120 individually or collectively, cause the electronic device 101 to determine a preparation action associated with the schedule based on the at least part of the schedule information, and to determine the alarm occurrence time of the automatic alarm corresponding the preparation action.

According to various embodiments, the one or more storage media may store instructions that, when executed by the at least one processor 120 individually or collectively, cause the electronic device 101 to calculate the required time 411 for the identified preparation operation, to identify the start time 405 of the preparation operation based on the start time 407 and the required time 411, and to determine a time earlier than the start time 405 as the alarm occurrence time 403 of the automatic alarm.

According to various embodiments, the one or more storage media may store instructions that, when executed by the at least one processor 120 individually or collectively, cause the electronic device 101 to determine the other alarms 903 and 905 that are different from the automatic alarm among the alarms generated in the electronic device 101, to determine whether the other alarms 903 and 905 exist within a specified time range designated based on the occurrence time of the automatic alarm, and to exclude generation of the automatic alarm based on the other alarms 903 and 905 exist within the specified time range.

According to various embodiments, the one or more storage media may store instructions that, when executed by the at least one processor 120 individually or collectively, cause the electronic device 101 to determine the other alarm 903 or 905 that is different from the automatic alarm among the alarms generated in the electronic device 101, to determine whether an occurrence time of the other alarms 903 and 905 falls within a specified time range designated based on the occurrence time of the automatic alarm, and to determine prior time or after time designated based on the occurrence time of the other alarms 903 and 905 as the alarm occurrence time 403 of the automatic alarm in response to determining that the occurrence time of the other alarms 903 and 905 falls within the specified time range.

According to various embodiments, the one or more storage media may store instructions that, when executed by the at least one processor 120 individually or collectively, cause the electronic device 101 to determine a category of the schedule based on the at least part of the schedule information, to set an occurrence cycle of the automatic alarm based on the determined category, and to generate the automatic alarm based on the set occurrence cycle.

According to various embodiments, the one or more storage media may store instructions that, when executed by the at least one processor 120 individually or collectively, cause the electronic device 101 to determine a category of the schedule based on the at least part of the schedule information, to set an intensity of occurrence of the automatic alarm based on the determined category, and to generate the automatic alarm based on the intensity of occurrence.

An operating method of the electronic device 101 according to various embodiments may include obtaining schedule information based on a user input, determining the start time 407 associated with a schedule based on at least part of the schedule information, setting a preparation time for generating of an automatic alarm generation based on the start time 407, determining whether a sleep state of a user is maintained using information received through the external device 102 in response to arrival of the preparation time, determining the alarm occurrence time 403 of the automatic alarm based on the at least part of the schedule information in response to determining that the sleep state of the user is maintained, and generating the automatic alarm based on the alarm occurrence time 403 of the automatic alarm.

According to various embodiments, the operating method of the electronic device 101 may include determining whether the sleep state of the user is maintained using information received through the external device 102 in response to arrival of the start time 407 associated with a schedule after generating the automatic alarm, determining the at least one other electronic device 104 based on the at least part of the schedule information in response to determining that the sleep state of the user is maintained, and transmitting a specified message to the determined at least one other electronic device 104.

According to various embodiments, the operating method of the electronic device 101 may include determining a category of the schedule based on the at least part of the schedule information, determining a first time as the alarm occurrence time 403 of the automatic alarm based on a first category requiring a first preparation time is identified, and determining a second time earlier than the first time as the alarm occurrence time 403 of the automatic alarm based on a second category requiring a second preparation time greater than the first preparation time is identified.

According to various embodiments, the operating method of the electronic device 101 may include determining an importance of the schedule based on the at least part of the schedule information, determining a first time as the alarm occurrence time 403 of the automatic alarm based on a first importance is identified, and determining a second time earlier than the first time as the alarm occurrence time 403 of the automatic alarm based on a second importance greater than the first importance is identified.

According to various embodiments, the operating method of the electronic device 101 may include identifying a preparation action related to the schedule based on at least part of the schedule information, and determining the alarm occurrence time of an automatic alarm corresponding to the identified preparation action.

According to various embodiments, the operating method of the electronic device 101 may include calculating the required time 411 for the identified preparation action, identifying the start time 405 of the preparation action based on the start time 407 and the required time 411, and determining a time earlier than the start time 405 as the alarm occurrence time 403 of the automatic alarm.

According to various embodiments, the operating method of the electronic device 101 may include determining the other alarms 903 and 905 that is different from the automatic alarm among the alarms generated in the electronic device 101, determining whether the other alarms 903 and 905 exist within a specified time range designated based on the occurrence time of the automatic alarm, and excluding generation of the automatic alarm based on the other alarms 903 and 905 exist within the specified time range.

According to various embodiments, the operating method of the electronic device 101 may include determining the other alarm 903 or 905 that is different from the automatic alarm among the alarms generated in the electronic device 101, determining whether an occurrence time of the other alarms 903 and 905 falls within a specified time range designated based on the occurrence time of the automatic alarm, and determining prior time or after time designated based on the occurrence time of the other alarms 903 and 905 as the alarm occurrence time 403 of the automatic alarm in response to determining that the occurrence time of the other alarms 903 and 905 falls within the specified time range.

According to various embodiments, the operating method of the electronic device 101 may include identifying a category related to the schedule based on at least part of the schedule information, setting an occurrence period of the automatic alarm based on the identified category, and generating the automatic alarm based on the set occurrence period.

According to various embodiments, the operating method of the electronic device 101 may include identifying a category related to the schedule based on at least part of the schedule information, setting occurrence intensity of the automatic alarm based on the identified category, and generating the automatic alarm based on the set occurrence intensity.

According to various embodiments, a non-transitory computer-readable medium may store computer-executable instructions which, when executed by the processor 120 of the electronic device 101, cause the electronic device 101 to perform operations including obtaining schedule information based on a user input, determining a start time associated with a schedule based on at least part of the schedule information, setting a preparation time for generating of an automatic alarm generation based on the start time, determining whether a sleep state of a user is maintained using information received through an external device based on arrival of the preparation time, determining an alarm occurrence time of the automatic alarm based on the at least part of the schedule information in response to determining that the sleep state of the user is maintained, and generating the automatic alarm based on the alarm occurrence time of the automatic alarm.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
communication circuitry configured to establish communication with an external device;
memory comprising one or more storage media storing instructions; and
at least one processor comprising processing circuitry,
wherein the instructions, when executed by the at least one processor individually or collectively, cause the electronic device to:
obtain schedule information based on a user input,
determine a start time associated with a schedule based on at least part of the schedule information,
set a preparation time for generating of an automatic alarm generation based on the start time,
in response to arrival of the preparation time, determine whether a sleep state of a user is maintained using information received through the communication circuitry,
in response to determining that the sleep state of the user is maintained, determine an alarm occurrence time of the automatic alarm based on the at least part of the schedule information, and
generate the automatic alarm based on the alarm occurrence time of the automatic alarm.

2. The electronic device of claim 1, wherein the instructions, when executed by the at least one processor individually or collectively, further cause the electronic device to:
in response to arrival of the start time associated with a schedule after generating the automatic alarm, determine whether the sleep state of the user is maintained using information received through the communication circuitry;
in response to determine that the sleep state of the user is maintained, determine at least one other electronic device based on the at least part of the schedule information; and
transmit a specified message to the determined at least one other electronic device.

3. The electronic device of claim 1, wherein the instructions, when executed by the at least one processor individually or collectively, further cause the electronic device to:
determine a category of the schedule based on the at least part of the schedule information;
based on a first category requiring a first preparation time is identified, determine a first time as the alarm occurrence time of the automatic alarm; and
based on a second category requiring a second preparation time greater than the first preparation time is identified, determine a second time earlier than the first time as the alarm occurrence time of the automatic alarm.

4. The electronic device of claim 1, wherein the instructions, when executed by the at least one processor individually or collectively, further cause the electronic device to:
determine an importance of the schedule based on the at least part of the schedule information;
based on a first importance is identified, determine a first time as the alarm occurrence time of the automatic alarm; and
based on a second importance greater than the first importance is identified, determine a second time earlier than the first time as the alarm occurrence time of the automatic alarm.

5. The electronic device of claim 1, wherein the instructions, when executed by the at least one processor individually or collectively, further cause the electronic device to:
determine a preparation action associated with the schedule based on the at least part of the schedule information; and
determine the alarm occurrence time of the automatic alarm corresponding the preparation action.

6. The electronic device of claim 5, wherein the instructions, when executed by the at least one processor individually or collectively, further cause the electronic device to:
calculate a required time for the determined preparation action;
based on the start time and the required time, identify a start point of the preparation action; and
determine a time earlier than the start time as the alarm occurrence time of the automatic alarm.

7. The electronic device of claim 3, wherein the instructions, when executed by the at least one processor individually or collectively, further cause the electronic device to:
determine other alarms that is different from the automatic alarm among the alarms generated in the electronic device;
determine whether the other alarms exist within a specified time range designated based on the occurrence time of the automatic alarm; and
exclude generation of the automatic alarm based on the other alarms exist within the specified time range.

8. The electronic device of claim 3, wherein the instructions, when executed by the at least one processor individually or collectively, further cause the electronic device to:
determine other alarms that is different from the automatic alarm among the alarms generated in the electronic device;
determine whether an occurrence time of the other alarms falls within a specified time range designated based on the occurrence time of the automatic alarm; and
in response to determine that the occurrence time of the other alarms falls within the specified time range, determine prior time and or after time designated based on the occurrence time of the other alarms as the alarm occurrence time of the automatic alarm.

9. The electronic device of claim 1, wherein the instructions, when executed by the at least one processor individually or collectively, further cause the electronic device to:
determine a category of the schedule based on the at least part of the schedule information;
set an occurrence cycle of the automatic alarm based on the determined category; and
generate the automatic alarm based on the set occurrence cycle.

10. The electronic device of claim 1, wherein the instructions, when executed by the at least one processor individually or collectively, further cause the electronic device to:
determine a category of the schedule based on the at least part of the schedule information;
set an intensity of occurrence of the automatic alarm based on the determined category; and
generate the automatic alarm based on the intensity of occurrence.

11. An operating method of an electronic device, the method comprising:
obtaining schedule information based on a user input;
determining a start time associated with a schedule based on at least part of the schedule information;
setting a preparation time for generating of an automatic alarm generation based on the start time;
in response to arrival of the preparation time, determining whether a sleep state of a user is maintained using information received through communication circuitry;
in response to determine that the sleep state of the user is maintained, determining an alarm occurrence time of the automatic alarm based on the at least part of the schedule information; and
generating the automatic alarm based on the alarm occurrence time of the automatic alarm.

12. The operating method of claim 11, further comprising:
in response to arrival of the start time associated with a schedule after generating the automatic alarm, determining whether the sleep state of the user is maintained using information received through the communication circuitry;
in response to determine that the sleep state of the user is maintained, determining at least one other electronic device based on the at least part of the schedule information; and
transmitting a specified message to the determined at least one other electronic device.

13. The operating method of claim 11, further comprising:
determining a category of the schedule based on the at least part of the schedule information;
based on a first category requiring a first preparation time is identified, determining a first time as the alarm occurrence time of the automatic alarm; and
based on a second category requiring a second preparation time greater than the first preparation time is identified, determining a second time earlier than the first time as the alarm occurrence time of the automatic alarm.

14. The operating method of claim 11, further comprising:
determining an importance of the schedule based on the at least part of the schedule information;
based on a first importance is identified, determining a first time as the alarm occurrence time of the automatic alarm; and
based on a second importance greater than the first importance is identified, determining a second time earlier than the first time as the alarm occurrence time of the automatic alarm.

15. The operating method of claim 11, further comprising:
determining a preparation action associated with the schedule based on the at least part of the schedule information; and
determining the alarm occurrence time of the automatic alarm corresponding the preparation action.

16. The operating method of claim 15, further comprising:
calculating a required time for the determined preparation action;
based on the start time and the required time, identifying a start point of the preparation action; and
determining a time earlier than the start time as the alarm occurrence time of the automatic alarm.

17. The operating method of claim 13, further comprising:
determining other alarms that is different from the automatic alarm among the alarms generated in the electronic device;
determining whether the other alarms exist within a specified time range designated based on the occurrence time of the automatic alarm; and
excluding generation of the automatic alarm based on the other alarms exist within the specified time range.

18. The operating method of claim 13, further comprising:
determining other alarms that is different from the automatic alarm among the alarms generated in the electronic device;
determining whether an occurrence time of the other alarms falls within a specified time range designated based on the occurrence time of the automatic alarm; and
in response to determining that the occurrence time of the other alarms falls within the specified time range, determining prior time and or after time designated based on the occurrence time of the other alarms as the alarm occurrence time of the automatic alarm.

19. One or more non-transitory computer-readable storage media storing computer-executable instructions that, when executed by one or more processors of an electronic device individually or collectively, cause the electronic device to perform operations comprising:
obtaining schedule information based on a user input;
determining a start time associated with a schedule based on at least part of the schedule information;
setting a preparation time for generating of an automatic alarm generation based on the start time;
in response to arrival of the preparation time, determining whether a sleep state of a user is maintained using information received through communication circuitry;
in response to determine that the sleep state of the user is maintained, determining an alarm occurrence time of the automatic alarm based on the at least part of the schedule information; and
generating the automatic alarm based on the alarm occurrence time of the automatic alarm.

20. The one or more non-transitory computer-readable storage media of claim 19, the operations further comprising:
in response to arrival of the start time associated with a schedule after generating the automatic alarm, determining whether the sleep state of the user is maintained using information received through the communication circuitry;
in response to determine that the sleep state of the user is maintained, determining at least one other electronic device based on the at least part of the schedule information; and
transmitting a specified message to the determined at least one other electronic device.
